(19) United States
(12) Patent Application Publication
(10) Pub. No.: US 2017/0311151 A1
(43) Pub. Date: Oct. 26, 2017

(54) MOBILE COMMUNICATION SYSTEM, COMMUNICATION CONTROL DEVICE, MOBILITY MANAGEMENT ENTITY, AND MOBILE COMMUNICATION METHOD

(71) Applicant: NTT DOCOMO, INC., Tokyo (JP)

(72) Inventors: Aki Ohashi, Tokyo (JP); Zhen Miao, Tokyo (JP); Tomonori Kagi, Tokyo (JP); Motohiro Abe, Tokyo (JP); Tetsuya Matsumoto, Tokyo (JP)

(73) Assignee: NTT DOCOMO, INC., Tokyo (JP)

(21) Appl. No.: 15/518,272

(22) PCT Filed: May 11, 2016
(86) PCT No.: PCT/JP2016/063998

§ 371 Date: Apr. 11, 2017

(30) Foreign Application Priority Data
May 15, 2015 (JP) 2015-099961

(51) Int. Cl. H04W 8/08; H04W 64/00; H04W 8/18

(52) U.S. Cl. CPC H04W 8/082; H04W 8/18; H04W 64/006

(57) ABSTRACT

A Home Subscriber Server (HSS) determines whether roaming of voice communication via an IP Multimedia Subsystem (IMS) is supported in the Visited Public Land Mobile Network (VPLMN) or not, and transmits to a mobility management entity (MME) a signal that includes a ‘voice supported’ or ‘voice not supported’ indicator that indicates whether the roaming is supported or not. The MME receives the indicator from the HSS, and transmits to a User Equipment (UE) an ‘Attach Accept’ as a response to an ‘Attach Request’ for the VPLMN. The MME then transmits to the UE, based on the indicator received from the HSS, the ‘Attach Accept’ that includes an indicator that indicates whether the roaming is supported or not.

### TECHNICAL FIELD

The present invention relates to a mobile communication system, a communication control device, a mobility management entity, and a mobile communication method. The present invention specifically relates to roaming control of voice communication in a visited public land mobile network of a mobile station.

### BACKGROUND ART

In Long Term Evolution (LTE) stipulated in 3rd Generation Partnership Project (3GPP), a so-called Voice over LTE (VoLTE) in which voice communication is realized via a packet switching (PS) domain called IP Multimedia Subsystem (IMS) can be provided.

A mobile station such as a smartphone, which supports the VoLTE, determines, based on the content of “IMS voice over PS Session Supported Indication” notified from a mobility management entity (MME), whether to perform voice communication by using the VoLTE or by executing fallback (CSFB) to a circuit switching (CS) domain of 3G (UTRAN) (for example, see Non-Patent Document 1).

Specifically, if the IMS voice over PS Session Supported Indication indicates ‘voice communication (voice supported) via IMS supported’, the mobile station executes the VoLTE.

### PRIOR ART DOCUMENT

### Non-Patent Document

Non-Patent Document 1: 3GPP TS 23.401 V12.6.0 Sub-clause 4.3.5.8 IMS voice over PS Session Supported Indication, 3rd Generation Partnership Project; Technical Specification Group Services and System Aspects; General Packet Radio Service (GPRS) enhancements for Evolved Universal Terrestrial Radio Access Network (E-UTRAN) access (Release 12), 3GPP, September, 2014.

### SUMMARY OF THE INVENTION

A mobile station can connect not only to a Home Public Land Mobile Network (HPLMN) operated by an operator that has a service contract with the mobile station but also to a Visited Public Land Mobile Network (VPLMN) operated by an another operator.

When connecting to the VPLMN, the mobile station determines, based on the ‘IMS voice over PS Session Supported Indication’ notified from an MME of the VPLMN, but not based on an MME of the HPLMN, whether the voice communication is supported or not. At this time, the MME of the VPLMN notifies the mobile station, based on a roaming agreement, specifically, based on presence of a VoLTE, roaming agreement, between an HPLMN operator and a VPLMN operator, whether voice communication via IMS is supported in the VPLMN or not.

However, a VPLMN (operator) that uniformly notifies, regardless of presence of the VoLTE roaming agreement, that voice communication via the IMS is supported is available. Therefore, for example, when a roaming agreement of the LTE itself is present but the VoLTE roaming agreement is absent, although a mobile station can transmit a request (Attach Request) to connect to the VPLMN, the voice communication via the IMS fails, and the mobile station cannot make a voice call.

The present invention has been made in view of the above circumstances. It is an object of the present invention to provide a mobile communication system, a communication control device, a mobility management entity, and a mobile communication method capable of avoiding failure when performing voice communication via IMS when a mobile station connects to a VPLMN.

A mobile communication system according to one aspect of the present invention includes a communication control device arranged on a home network of a mobile station; a mobility management entity arranged on a visited network of the mobile station; and a multimedia subsystem that processes packets for voice communication.

The communication control device includes a roaming determining unit that determines whether roaming of voice communication via the multimedia subsystem is supported in the visited network or not; and an indicator transmitting unit that transmits to the mobility management entity, based on the result of the roaming determination executed by the roaming determining unit, a signal that includes a first support indicator that indicates whether the roaming is supported or not.

The mobility management entity includes an indicator receiving unit that receives the first support indicator from the communication control device; and a response transmitting unit that transmits to the mobile station a response for a request to connect to the visited network received from the mobile station. The response transmitting unit transmits to the mobile station, based on the first support indicator received by the indicator receiving unit, the response that includes a second support indicator that indicates whether the roaming is supported or not.

A communication control device according to another aspect of the present invention is arranged on a home network of a mobile station and used in a mobile communication system including a mobility management entity arranged on a visited network of the mobile station and a multimedia subsystem that processes packets for voice communication.

The communication control device includes a roaming determining unit that determines whether roaming of voice communication via the multimedia subsystem is supported in the visited network or not; and an indicator transmitting unit that transmits to any one of the mobility management entity and the mobile station, based on the result of the roaming determination executed by the roaming determining unit, a signal that includes a first support indicator that indicates whether the roaming is supported or not.

A mobility management entity according to still another aspect of the present invention is arranged on a visited network of a mobile station and used in a mobile communication system that includes a communication control device arranged on a home network of the mobile station and a multimedia subsystem that processes packets for voice communication. The mobility management entity includes an indicator receiving unit that receives from the communication control device a first support indicator that indicates whether roaming of voice communication via the multimedia subsystem is supported in the visited network or not; and a response transmitting unit that transmits to the mobile station a response for a request to connect to the visited network received from the mobile station. The response transmitting unit transmits to the mobile station, based on the first support indicator received by the indicator receiving unit, the response that includes a second support indicator that indicates whether the roaming is supported or not.

A mobile communication method according to still another aspect of the present invention is implemented in a mobile communication system that includes a communication control device arranged on a home network of a mobile station, a mobility management entity arranged on a visited network of the mobile station, and a multimedia subsystem that processes packets for voice communication.

The mobile communication method includes, transmitting, in which the communication control device transmits to the mobility management entity a signal that includes a first support indicator that indicates whether roaming of voice communication via the multimedia subsystem is supported in the visited network or not; receiving, in which the mobility management entity receives the first support indicator from the communication control device; and transmitting, in which the mobility management entity transmits to the mobile station a response for a request to connect to the visited network from the mobile station. When transmitting the response to the mobile station in the transmitting, the mobility management entity transmits to the mobile station, based on the received first support indicator, the response that includes a second support indicator that indicates whether the roaming is supported or not.

### BRIEF DESCRIPTION OF DRAWINGS

FIG. 1 is an overall structural diagram of a mobile communication system 10.

FIG. 2 is a functional block diagram of an HSS 100 according to a first embodiment of the present invention.

FIG. 3 is a functional block diagram of an MME 300 according to the first embodiment.

FIG. 4 is a diagram that shows an operation sequence of notifying a UE 20 according to the first embodiment of an indicator that indicates whether roaming is supported or not.

FIG. 5 is a diagram for explaining the operation of notifying the UE 20 according to the first embodiment of an indicator that indicates whether roaming is supported or not.

FIG. 6 is a diagram that shows operation flow of the HSS 100 according to the first embodiment.

FIG. 7 is a diagram that shows operation flow of the MME 300 according to the first embodiment.

FIG. 8 is a diagram for explaining an operation of notifying a UE 20 according to a second embodiment of an indicator that indicates whether roaming is supported or not.

FIG. 9 is a functional block diagram of a PGW 200 according to the second embodiment.

FIG. 10 is a diagram for explaining an operation of notifying a UE 20 according to a third embodiment of an indicator that indicates whether roaming is supported or not.

FIG. 11 is a functional block diagram of an SIP server 510 according to the third embodiment.

### MODES FOR CARRYING OUT THE INVENTION

Exemplary embodiments are explained below with reference to the accompanying drawings. In the drawings, structural elements having the same function or configuration are indicated by the same or similar reference numerals and the explanation thereof is appropriately omitted.

### First Embodiment

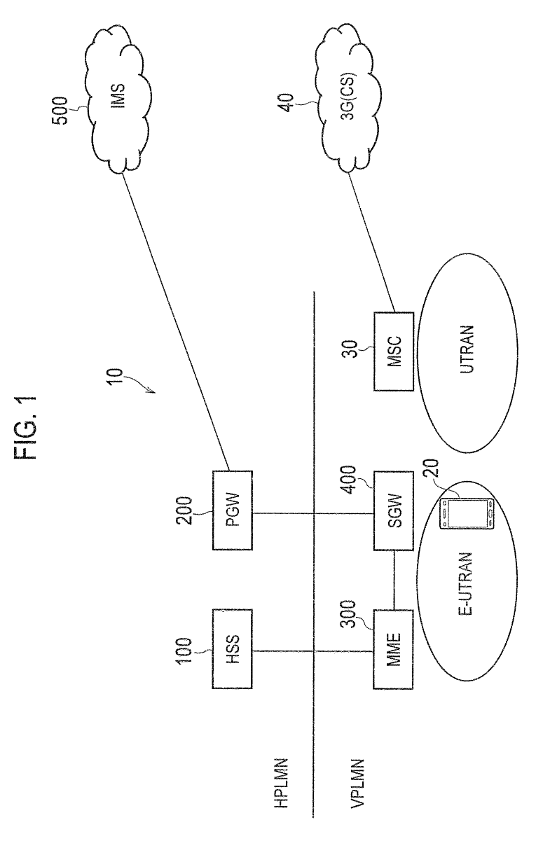

A first embodiment of the present invention is explained below with reference to FIGS. 1 to 7. In the present embodiment, a control (Attach) performed in an EMM (EPS Mobility Management) layer is cited as an example.

(1) Overall Structural Configuration of Mobile Communication System

FIG. 1 is an overall structural diagram of a mobile communication system 10 according to the present embodiment. As shown in FIG. 1, the mobile communication system 10 includes a mobile station 20 (hereinafter referred to as a User Equipment 20 (UE 20)), and a Home Subscriber Server 100 (hereinafter referred to as an HSS 100) and a PDN Gateway 200 (hereinafter referred to as a PGW 200), specifically which are arranged on a Home Public Land Mobile Network (HPLMN).

Moreover, the mobile communication system 10 includes a mobility management entity 300 (hereinafter referred to as an MME 300) and a Serving Gateway 400 (hereinafter referred to as an SGW 400), specifically which are arranged on a Visited Public Land Mobile Network (VPLMN) of the UE 20.

The PGW 200 is connected to an IP multimedia subsystem 500 (hereinafter referred to as an IMS 500) via an SGi interface. However, the IMS 500 can be connected to a device arranged on the VPLMN via some other interface.

The UE 20 can be radio connected to E-UTRAN, which is a radio access network as per the Long Term Evolution (LTE) specifications, and UTRAN, which is a 3G radio access network. The UE 20 can communicate with the MME 300 or the SGW 400 via the E-UTRAN. Moreover, the UE 20 can communicate with a Mobile Switching Center 30 (hereinafter referred to as an MSC 30) via the UTRAN.

The MSC 30 is a switching equipment for a circuit switching service and is connected to a circuit switching domain (hereinafter referred to as a CS domain 40).

The HSS 100 is a database of information regarding subscribers of the mobile communication system 10, specifically, an HPLMN operator (telecommunications carrier), and manages subscriber (mobile station) authentication information and visited area information.

The PGW 200 provides a function to establish a connection between the UE 20 and a network such as the IMS 500. The MME 300 is arranged on the VPLMN of the UE 20 and is operative to control the movement of the UE 20 on the VPLMN. The SGW 400 is a packet switching equipment arranged on the LTE network to transmit and receive user data to and from the PGW 200.

The IMS 500 is an IP-based multimedia subsystem, and can process packets for voice communication (including emergency call).

(2) Functional Block Configuration of Mobile Communication System

Functional block configurations of the HSS 100 and the MME 300 included in the mobile communication system 10 are explained below.

(2.1) HSS 100

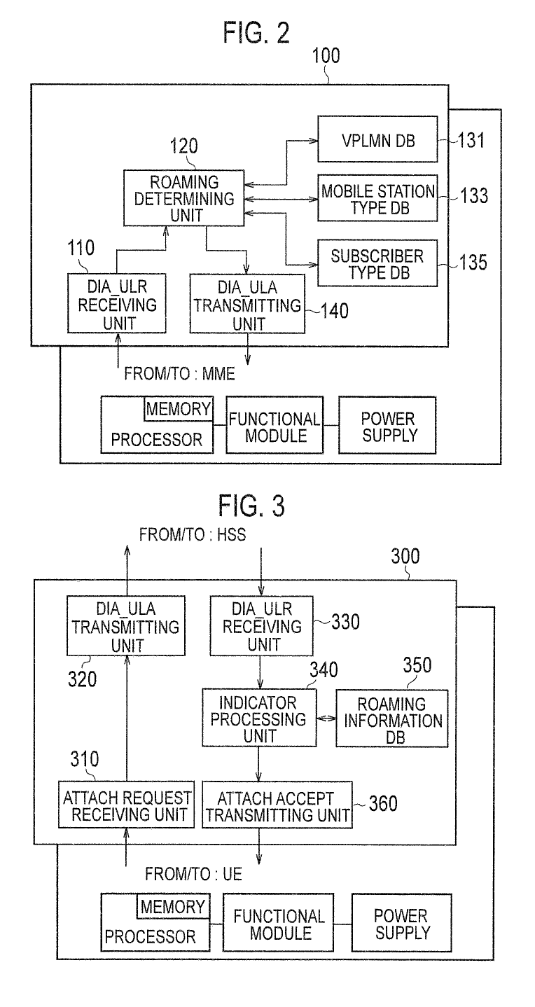

FIG. 2 is a functional block diagram of the HSS 100. As shown in FIG. 2, the HSS 100 includes a Dia_ULR receiving unit 110, a roaming determining unit 120, a VPLMN DB 131, a mobile station type DB 133, a subscriber type DB 135, and a Dia_ULA transmitting unit 140. Each functional block is realized by hardware elements such as a processor (including memory), a functional module (such as a network IF), and a power supply.

In the present embodiment, the HSS 100 constitutes a communication control device arranged on a HPLMN of a mobile station.

The Dia_ULR receiving unit 110 receives from the MME 300 a Dia_ULR according to the Diameter protocol.

The roaming determining unit 120 determines, according to the Dia_ULR received by the Dia_ULR receiving unit 110, whether roaming of the UE 20 is supported in the VPLMN or not. Specifically, the roaming determining unit 120 determines whether the roaming of voice communication (Voice over LTE; hereinafter referred to as VoLTE) via the IMS 500 is supported in the VPLMN or not. In other words, the roaming determining unit 120 determines whether the UE 20 can execute the VoLTE in the VPLMN or not.

The roaming determining unit 120 refers to the VPLMN DB 131, the mobile station type DB 133, and the subscriber type DB 135, and determines whether the roaming is supported or not.

Specifically, the roaming determining unit 120 refers to the VPLMN DB 131, and determines whether the roaming is supported or not based on presence of a VoLTE roaming agreement between the HPLMN and the VPLMN.

Moreover, the roaming determining unit 120 refers to the mobile station type DB 133, and can determine whether the roaming is supported or not based on the type of the mobile station. A type of the mobile station is a format of the mobile station that supports a VoLTE function, connection compatibility between the mobile station of that type and the VPLMN, and the like.

Furthermore, the roaming determining unit 120 refers to the subscriber type DB 135, and can determine whether the roaming is supported or not, based on the user type of the mobile station. A user type (subscriber type) of the mobile station is a type of contract with the HPLMN operator and the like, and includes availability of the VoLTE, contract data communication amount, and the like.

The Dia_ULA transmitting unit 140 transmits to the MME 300 a Dia_ULA according to the Diameter protocol. Specifically, based on the result of the roaming determination executed by the roaming determining unit 120, the Dia_ULA transmitting unit 140 transmits to a mobility management entity a signal that includes a first support indicator that indicates whether the roaming is supported or not. In the present embodiment, the Dia_ULA transmitting unit 140 constitutes an indicator transmitting unit.

More specifically, when the roaming is supported, the Dia_ULA transmitting unit 140 transmits a Dia_ULA that includes ‘voice supported’, which is an indicator that indicates that the roaming is supported. On the other hand, when the roaming is not supported, the Dia_ULA transmitting unit 140 transmits a Dia_ULA that includes ‘voice not supported’, which is an indicator that indicates that the roaming is not supported.

Such indicators, however, are not stipulated in the existing 3GPP TS and therefore are newly stipulated.

(2.2) MME 300

FIG. 3 is a functional block diagram of the MME 300. As shown in FIG. 3, the MME 300 includes an Attach Request receiving unit 310, a Dia_ULR transmitting unit 320, a Dia_ULA receiving unit 330, an indicator processing unit 340, a roaming information DB 350, and an Attach Accept transmitting unit 360. Each functional block is realized by hardware elements such as a processor (including memory), a functional module (such as a network IF), and a power supply.

The Attach Request receiving unit 310 receives from the UE 20 an Attach Request, which is a request to connect to the VPLMN.

The Dia_ULR transmitting unit 320 transmits to the HSS 100 a Dia_ULR according to the Diameter protocol according to the Attach Request received by the Attach Request receiving unit 310.

The Dia_ULA receiving unit 330 receives the Dia_ULA transmitted by the HSS 100. In the present embodiment, the Dia_ULA receiving unit 330 constitutes an indicator receiving unit that receives the first support indicator from the communication control device.

The indicator processing unit 340 executes processing based on the indicator (‘voice supported’ or ‘voice not supported’) included in the Dia_ULA received by the Dia_ULA receiving unit 330. Specifically, the indicator processing unit 340 determines a type of the indicator (‘voice supported’ or ‘voice not supported’) to be included in an Attach Accept based on the type of the indicator included in the Dia_ULA.

When no indicator is included in the Dia_ULA received by the Dia_ULA receiving unit 330, the indicator processing unit 340 refers to the roaming information DB 350 and determines the type of the indicator (‘voice supported’ or ‘voice not supported’) to be included in the Attach Accept. Specifically, when it is indicated in the roaming information DB 350 that the roaming of the UE 20 from which the Attach Request was transmitted is supported in the VPLMN, the indicator processing unit 340 determines to include the ‘voice supported’ indicator in an Attach Accept.

The indicators (‘voice supported’ and ‘voice not supported’), as explained above, are stipulated in 3GPP TS23.401 (Sub-clause 4.3.5.8).

The Attach Accept transmitting unit 360 transmits to the UE 20 an Attach Accept as a response to the Attach Request received from the UE 20. Upon receiving the Attach Accept, the UE 20 connects to an E-UTRAN in the VPLMN.

In the present embodiment, the Attach Accept transmitting unit 360 constitutes a response transmitting unit that transmits to a mobile station a response for a request to connect to a VPLMN transmitted from the mobile station.

The Attach Accept transmitting unit 360 transmits to the UE 20, based on the indicator (the first support indicator) received by the Dia_ULA receiving unit 330, an Attach Accept that includes an indicator (a second support indicator) that indicates whether roaming is supported or not.

Specifically, the Attach Accept transmitting unit 360 transmits to the UE 20 an Attach Accept that includes a ‘voice supported’ or ‘voice not supported’ indicator specified by the indicator processing unit 340.

(3) Operation of Mobile Communication System

An operation of the mobile communication system 10 is explained below. Specifically, an operation of connecting to the HSS 100 arranged on the HPLMN and instructing the UE 20 that is located in the service area of the VPLMN whether roaming of the voice communication (VoLTE) is supported or not is explained below.

(3.1) Operation Sequence

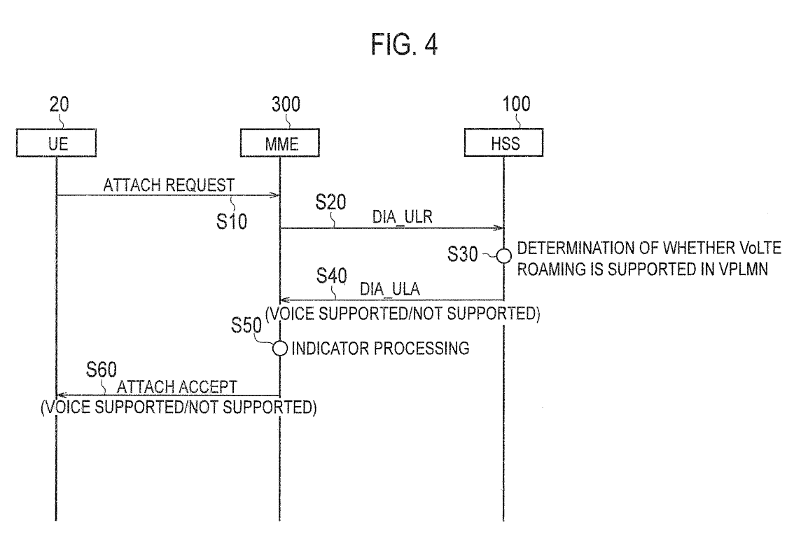

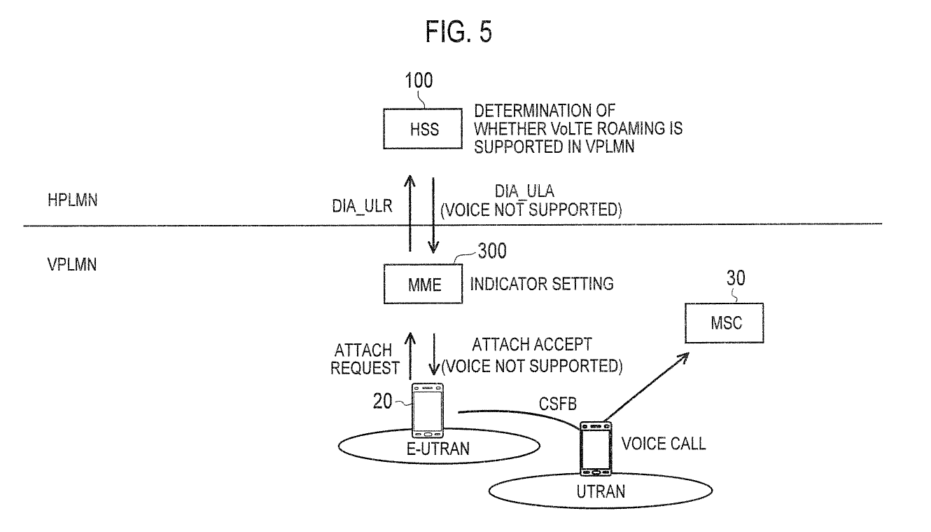

FIG. 4 shows an operation sequence of notifying the UE 20 of an indicator that indicates whether the roaming is supported or not. FIG. 5 is a diagram for explaining the operation of notifying the UE 20 of an indicator that indicates whether the roaming is supported or not.

As shown in FIGS. 4 and 5, the UE 20 transmits an Attach Request to the MME 300 to connect to an E-UTRAN in the VPLMN (S10 in FIG. 4 (hereinafter, the same figure)). Upon receiving the Attach Request, the MME 300 transmits a Dia_ULR to the HSS 100 (S20).

The HSS 100 determines, based on the received Dia_ULR, whether the VoLTE roaming is supported in the VPLMN or not (S30).

The HSS 100 returns to the MME 300, based on the result of the roaming determination, a Dia_ULA that includes a ‘voice supported’ or ‘voice not supported’ indicator (S40).

Based on the type of the indicator included in the Dia_ULA, the MME 300 determines a type of the indicator (‘voice supported’ or ‘voice not supported’) to be included in an Attach Accept (S50) .

The MME 300 returns to the UE 20 an Attach Accept that includes the determined indicator (S60).

FIG. 5 conceptually shows the operations performed at Steps S10 to S60 explained above. In FIG. 5, a case in which the HSS 100 determines that the VoLTE roaming is not possible in the VPLMN and specifies the ‘voice not supported’ indicator is shown as an example.

Upon receiving the Attach Accept that includes the ‘voice not supported’ indicator, the UE 20 recognizes that the VoLTE via the E-UTRAN (LTE) in the VPLMN is not possible, and executes fallback (CSFB) to UTRAN (3G CS). As a result, the UE 20 connects to the circuit switching domain and makes a voice call to the MSC 30.

(3.2) Device Operation Flow

Operations of devices when performing the above operation sequence are explained below. Specifically, the operation flow of the HSS 100 arranged on the HPLMN, and the operation flow of the MME 300 arranged on the VPLMN are explained.

(3.2.1) Operation Flow of HSS 100

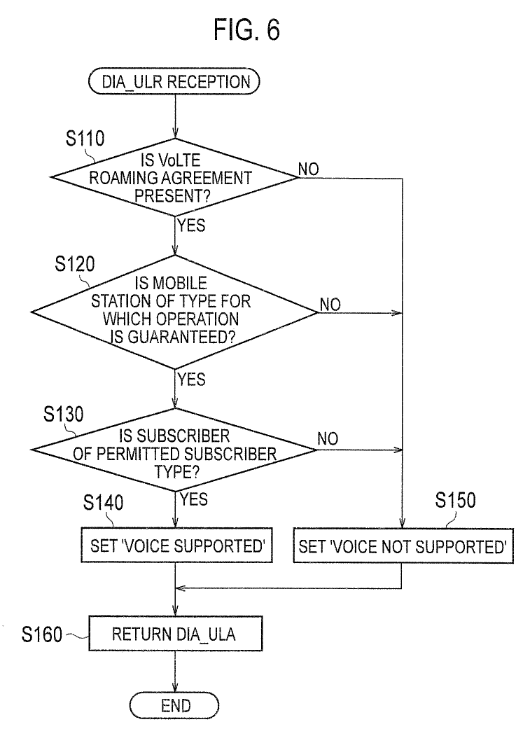

FIG. 6 shows an operation flow of the HSS 100 arranged on the HPLMN. As shown in FIG. 6, the HSS 100 determines, upon receiving a Dia_ULR from the MME 300, whether the VoLTE roaming agreement is present between the HPLMN and the VPLMN or not (S110).

When the VoLTE roaming agreement is present between the HPLMN and the VPLMN, the MSS 100 determines whether the UE 20 is of a type of the mobile station for which operation is guaranteed in the VPLMN (S120). Specifically, as explained above, the HSS 100 checks whether the UE 20 is of a format (model) of the mobile station that supports the VoLTE function, whether there is a connection compatibility between the mobile station and the VPLMN, and the like.

When the UE 20 is of a mobile station type for which operation is guaranteed, the HSS 100 determines whether the user type (subscriber type) of the mobile station is a user type of the mobile station in which the VoLTE roaming is permitted (S130).

When the subscriber type of the mobile station is a subscriber type in which the VoLTE roaming is permitted, the HSS 100 sets ‘voice supported’ as an indicator to be included in a Dia_ULA to be returned to the MME 300 (S140). On the other hand, when the VoLTE roaming agreement is not present, when the type of the mobile station is not a type for which operation is guaranteed, or when the subscriber type is a type in which the VoLTE roaming is not permitted, the HSS 100 sets ‘voice not supported’ as an indicator to be included in a Dia_ULA to be returned to the MME 300 (S150).

The HSS 100 returns to the MME 300 a Dia_ULA that includes a ‘voice supported’ or ‘voice not supported’ indicator (S160).

(3.2.2) Operation Flow of MME 300

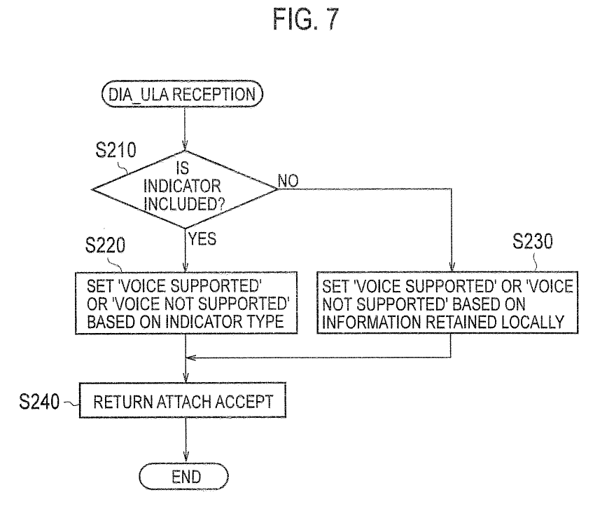

FIG. 7 shows an operation flow of the MME 300 arranged on the VPLMN. As shown in FIG. 7, the MME 300 determines, upon receiving the Dia_ULA from the HSS 100, whether the Dia_ULA includes an indicator (‘voice supported’ or ‘voice not supported’) that indicates whether the VoLTE roaming is supported or not (S210).

If an indicator is included, the MME 300 sets, based on the type of the received indicator, ‘voice supported’ or ‘voice not supported’ as an indicator to be included in an Attach Accept to be returned to the UE 20 (S220). Specifically, the MME 300 sets ‘voice supported’ indicator when the Dia_ULA includes ‘voice supported’ indicator, and sets ‘voice not supported’ indicator when the Dia_ULA includes ‘voice not supported’ indicator.

On the other hand, if no indicator is included, the MME 300 sets, based on the information retained locally (in the roaming information DB 350), ‘voice supported’ or ‘voice not supported’ as an indicator to be included in an Attach Accept to be returned to the UE 20 (S230).

Specifically, as explained above, when it is indicated in the roaming information DB 350 that the roaming of the UE 20 arranged on the HPLMN is supported in the VPLMN, the MME 300 determines to include the ‘voice supported’ indicator in an Attach Accept.

The MME 300 returns to the UE 20 an Attach Accept that includes the set ‘voice supported’ or ‘voice not supported’ indicator (S240).

(4) Effects and Advantages

According to the present embodiment, the following effects and advantages can be obtained. The HSS 100 determines, based on the Dia_ULR received from the MME 300, whether roaming of the voice communication (VoLTE roaming) via the IMS 500 is supported in the VPLMN or not. The HSS 100 returns to the MME 300 a Dia_ULA that includes an indicator (‘voice supported’ or ‘voice not supported’) that indicates whether the roaming is supported or not. Furthermore, the MME 300 returns to the UE 20 an Attach Accept that includes the same indicator.

With this configuration, the UE 20 can quickly determine whether the roaming in the VPLMN in whose service area the UE 20 is present is supported or not. Therefore, attempt of the UE 20 to perform the voice communication via the IMS 500 in the VPLMN even though the roaming is not supported is prevented. In other words, failure to perform voice communication via the IMS 500 when the UE 20 connects to the VPLMN can be avoided.

In particular, regardless of presence of the VoLTE roaming agreement, even when the VPLMN (operator) that uniformly notifies, regardless of presence of the VoLTE roaming agreement, that voice communication via the IMS is supported is present in the network, failure to perform voice communication as explained above can be reliably avoided.

However, before VoLTE roaming is started in the VPLMN, the possibility of voice communication via the IMS is determined by an MME arranged on the HPLMN, in other words, an MME managed by the HPLMN operator. Therefore, the above problem was not severe.

In the present embodiment, the HSS 100, based on presence of voice communication (VoLTE) roaming agreement between the HPLMN and the VPLMN, can determine whether the roaming is supported or not. With this configuration, after confirming at the HPLMN side that the roaming agreement is present between the HPLMN and the VPLMN, the UE 20 can be caused to reliably execute the voice communication.

In the present embodiment, the HSS 100 can determine whether the roaming is supported or not based on type of the UE 20. With this configuration, after confirming at the HPLMN side that the mobile station type is compatible with the VPLMN, the UE 20 can be caused to reliably execute the voice communication.

In the present embodiment, the HSS 100 can determine whether the roaming is supported or not based on the user type (subscriber type) of the UE 20. With this configuration, after confirming at the HPLMN side that the subscriber type of the UE 20 is compatible with the VPLMN, the UE 20 can be caused to reliably execute the voice communication.

### Second Embodiment

A second embodiment of the present invention is explained below. This embodiment is explained by taking a control (EPS bearer context) performed in an ESM (EPS Session Management) layer as an example. In the following explanation, structural elements different from the first embodiment are mainly explained, and explanation of the common structural elements is appropriately omitted.

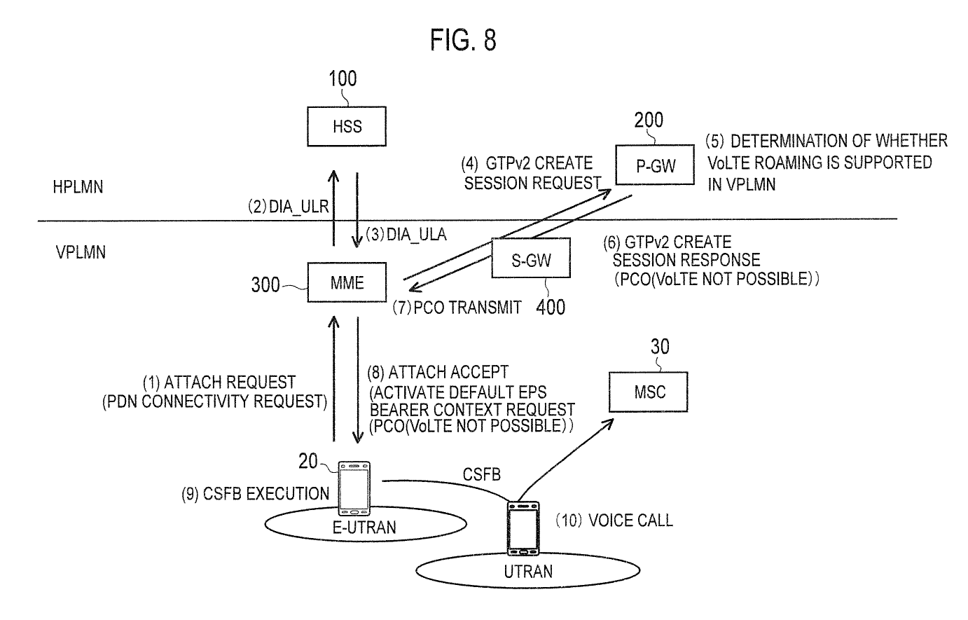

FIG. 8 is a diagram for explaining an operation of notifying the UE 20 of an indicator that indicates whether roaming is supported or not.

As shown in FIG. 8, in the present embodiment, the MME 300 transmits to the PGW 200 a GTPv2 Create Session Request based on the PDN connectivity request included in the Attach Request received from the UE 20 ((2) and (4) of FIG. 8).

Upon receiving the GTPv2 Create Session Request, the PGW 200 determines whether the VoLTE roaming is supported or not in the VPLMN by performing the same operation as that of the HSS 100 according to the first embodiment ((5) same figure as above). The PGW 200 sets for the UE 20 an indicator (the first support indicator) that indicates whether the VoLTE roaming is supported or not based on the result of the roaming determination.

Specifically, if VoLTE roaming is supported, the PGW 200 sets “PCO (VoLTE possible)” as an indicator. PCO is an abbreviation of Protocol Configuration Option. On the other hand, if VoLTE roaming is not supported, the PGW 200 sets “PCO (VoLTE not possible)” as the indicator. In the example of FIG. 8, a case in which “PCO (VoLTE not possible)” is set is shown. Such indicators, however, are not stipulated in the existing 3GPP TS and therefore are newly stipulated.

The PGW 200 returns to the MME 300 a GTPv2 Create Session Response that includes the “PCO (VoLTE not possible)” as an indicator (6).

The MME 300 transmits (forwards) the PCO included in the received GTPv2 Create Session Response as is, and includes that same PCO, specifically, the “PCO (VoLTE not possible)” (the second support indicator) indicator in an EPS Bearer Context Request (specifically, an Active Default EPS Bearer Context Request) to be included in an Attach Accept to be returned to the UE 20 ((7) and (8) same as above).

Upon receiving the Attach Accept that includes the PCO, the UE 20 recognizes that VoLTE via the E-UTRAN (LTE) of the VPLMN is not possible. As a result, the UE 20 executes the fallback (CSFB) to the UTRAN (3G CS) and makes a voice call to the MSC 30 ((9) and (10)).

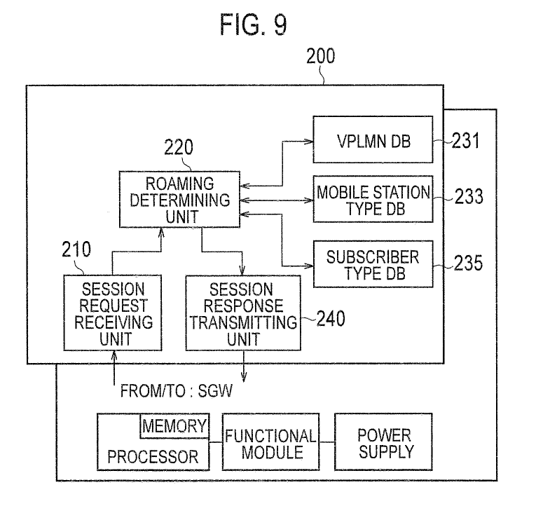

FIG. 9 is a functional block diagram of the PGW 200 according to the present embodiment. In the present embodiment, the PGW 200 constitutes a communication control device. As shown in FIG. 9, the PGW 200 includes a Session Request receiving unit 210, a roaming determining unit 220, a VPLMN DB 231, a mobile station type DB 233, a subscriber type DB 235, and a Session Response transmitting unit 240.

The functional block configuration of the PGW 200 is substantially the same as that of the HSS 100 according to the first embodiment.

The main difference between the PGW 200 and the HSS 100 is that the PGW 200 includes the Session Request receiving unit 210 that receives a GTPv2 Create Session Request from the MME 300 via the SGW 400, and the Session Response transmitting unit 240 that transmits a GTPv2 Create Session Response to the MME 300 via the SGW 400.

In this manner, in the present embodiment, though the PGW 200 determines whether the roaming is possible or not by performing the control in the ESM layer (EPS bearer context), the same effects as that of the first embodiment are obtained. Whether to cause the HSS 100 or the PGW 200 to determine whether the roaming is possible can be decided depending on specifications such as network configurations of the HPLMN and the VPLMN.

### Third Embodiment

A third embodiment of the present invention is explained below. The present embodiment is explained by taking a control (registration) performed in an IMS (IP Multimedia Subsystem) layer as an example. In the following explanation, too, structural elements different from the first embodiment explained above are mainly explained, and explanation of the common structural elements is appropriately omitted.

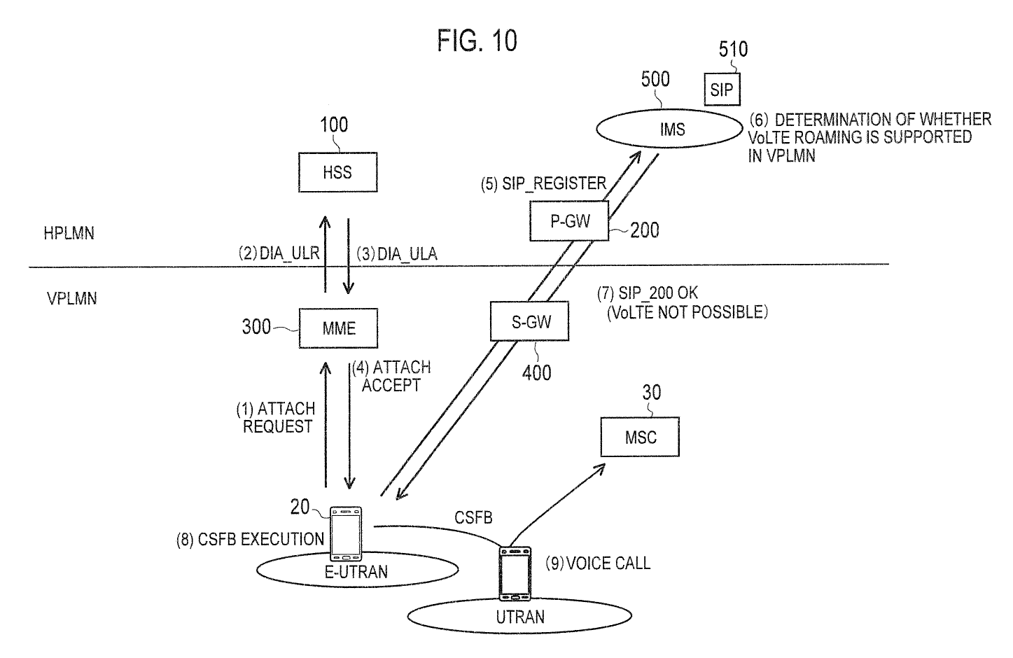

FIG. 10 is a diagram for explaining an operation of notifying the UE 20 of an indicator that indicates whether roaming is supported or not.

As shown in FIG. 10, in the present embodiment, following the transmission of the Attach Request and the reception of the Attach Accept ((1) to (4) of FIG. 10), the UE 20 transmits an SIP_REGSISTER to the IMS 500, specifically, to the SIP server 510 that constitutes the IMS 500 (5).

Upon receiving the SIP_REGSISTER, the SIP server 510 determines whether the VoLTE roaming is possible in the VPLMN or not by performing the same operation as that of the HSS 100 according to the first embodiment (6). The SIP server 510 sets for the UE 20 an indicator (the first support indicator) that indicates whether the VoLTE roaming is supported or not based on the result of the roaming determination.

Specifically, if the VoLTE roaming is supported, the SIP server 510 transmits to the UE 20 an “SIP 200 OK (VoLTE possible)” an SIP message that includes the corresponding indicator.

On the other hand, if the VoLTE roaming is not supported, the SIP server 510 transmits to the UE 20 an “SIP 200 OK (VoLTE not possible)”, an SIP message that includes the corresponding indicator.

In the example of FIG. 10, a case in which “SIP 200 OK (VoLTE not possible)” is transmitted is shown. Such indicators, however, are not stipulated in the existing 3GPP TS and therefore are newly stipulated.

Upon receiving the “SIP 200 OK (VoLTE not possible)” via the PGW 200 and the SGW 400, the UE 20 recognizes that the VoLTE via the E-UTRAN of the VPLMN (LTE) is not possible. As a result, the UE 20 executes the fallback (CSFB) to the UTRAN (3G CS) and makes a voice call to the MSC 30 ((8) and (9)).

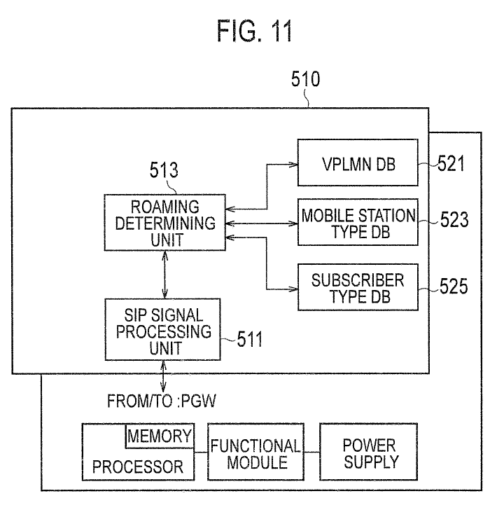

FIG. 11 is a functional block diagram of the SIP server 510 according to the present embodiment. In the present embodiment, the SIP server 510 constitutes a communication control device. As shown in FIG. 11, the SIP server 510 includes a SIP signal processing unit 511, a roaming determining unit 513, a VPLMN DB 521, a mobile station type DB 523, and a subscriber type DB 525.

The functional block configuration of the SIP server 510 is substantially the same as that of the HSS 100 of the first embodiment. The main difference between the SIP server 510 and the HSS 100 is that the SIP server 510 includes the SIP signal processing unit 511 that transmits and receives SIP messages.

Moreover, the SIP signal processing unit 511 transmits to the UE 20 the “SIP 200 OK (VoLTE not possible)” via the PGW 200 and the SGW 400.

In this manner, in the present embodiment, although the SIP server 510 determines whether the roaming is possible or not by performing control in the IMS layer (Registration), the same effects as that of the first embodiment are obtained. Whether to cause the HSS 100 or the SIP server 510 to determine whether the roaming is possible can be decided depending on specifications such as network configurations of the HPLMN, the VPLMN, and the IMS 500.

### Other Embodiments

The present invention has been explained above in detail by way of the embodiments. However, the present invention is not limited to the above embodiments, and various modifications and improvements of the present invention will be apparent from the above disclosure to those skilled in the art.

For example, in the first embodiment explained above, when all the conditions, namely (i) VoLTE roaming agreement, (ii) the mobile station is of a type with guaranteed operation in the VPLMN, and (iii) the user type (subscriber type), are satisfied, an indicator (voice supported) that indicates that voice communication is possible is set. However, whether the voice communication is supported or not can be determined on the basis of any one of these determination conditions mentioned in (i) to (iii).

Moreover, in the first to third embodiments, the VoLTE roaming in the VPLMN is controlled (regulated) by including a ‘voice supported’ or ‘voice not supported’ indicator in an Attach Accept. However, instead of performing this control by using the Attach Accept, VoLTE roaming in the VPLMN can be controlled by regulating the IMS Registration in which the UE 20 is registered on the IMS 500. For example, in the third embodiment, by transmitting a specific SIP message (for, example, SIP_4xx, where a predetermined number is set for xx) to the UE 20, IMS Registration can be regulated, and consequently, VoLTE roaming of the UE 20 can be regulated.

Furthermore, the sequence of the processes in the operation sequences and the flows shown in the above embodiments can be reshuffled, as long as the sequence is kept consistently the same in all operation sequences and flows.

Moreover, for example, in the first embodiment, only the ‘voice supported’ indicator can be transmitted, and not transmitting the ‘voice supported’ indicator can be implicitly interpreted to mean that the VoLTE roaming is not supported. This method can be used to determine that the VoLTE roaming is not supported.

In the embodiments explained above, LTE is cited as an example. However, LTE-Advanced is also included in the LTE, and the communication type is not limited only to the LTE. Moreover, the radio access network, which is a fallback destination of the UE 20, is not limited to UTRAN, and can be GERAN and the like.

The present invention has been explained above in detail byway of embodiment of the invention. However, no part of the above disclosure or drawings shall be understood as limiting the scope of the present invention. Various alternative embodiments, examples and operational techniques will become apparent to those skilled in the art after reading this disclosure.

The entire contents of Japanese Patent Application No. 2015-099961 (filed on May 15, 2015) are incorporated in the description of the present application by reference.

### INDUSTRIAL APPLICABILITY

According to the mobile communication system, the communication control device, the mobility communication entity, and the mobile communication method explained above, failure to perform voice communication via IMS when the mobile station connects to the VPLMN can be avoided.

### EXPLANATION OF REFERENCE NUMERALS

10 Mobile communication system
20 UE
30 MSC
40 CS domain
100 HSS
110 Dia_ULR receiving unit
120 Roaming determining unit
131 VPLMN DB
133 Mobile station type DB
135 Subscriber type DB
140 Dia_ULA transmitting unit
200 PGW
210 Session Request receiving unit
220 Roaming determining unit
231 VPLMN DB
233 Mobile station type DB
235 Subscriber type DB
240 Session Response transmitting unit
300 MME
310 Attach Request receiving unit
320 Dia_ULR transmitting unit
330 Dia_ULA receiving unit
340 Indicator processing unit
350 Roaming information DB
360 Attach Accept transmitting unit
400 SGW
500 IMS
510 SIP server
511 SIP signal processing unit
513 Roaming determining unit
521 VPLMN DB
523 Mobile station type DB
525 Subscriber type DB

1. A mobile communication system comprising:
a communication control device arranged on a home network of a mobile station;
a mobility management entity arranged on a visited network of the mobile station; and
a multimedia subsystem that processes packets for voice communication, wherein
the communication control device includes
a roaming determining unit that determines whether roaming of voice communication via the multimedia subsystem is supported in the visited network or not; and
an indicator transmitting unit that transmits to the mobility management entity, based on the result of the roaming determination executed by the roaming determining unit, a signal that includes a first support indicator that indicates whether the roaming is supported or not, and
the mobility management entity includes
an indicator receiving unit that receives the first support indicator from the communication control device; and
a response transmitting unit that transmits to the mobile station a response for a request to connect to the visited network received from the mobile station, wherein
the response transmitting unit transmits to the mobile station, based on the first support indicator received by the indicator receiving unit, the response that includes a second support indicator that indicates whether the roaming is supported or not.

2. The mobile communication system as claimed in claim 1, wherein the roaming determining unit determines whether the roaming is supported or not based on presence of a roaming agreement for the voice communication between the home network and the visited network.

3. The mobile communication system as claimed in claim 1, wherein the roaming determining unit determines whether the roaming is supported or not based on the mobile station type.

4. The mobile communication system as claimed in claim 1, wherein the roaming determining unit determines whether the roaming is supported or not based on a user type of the mobile station.

5. A communication control device that is arranged on a home network of a mobile station and used in a mobile communication system including a mobility management entity arranged on a visited network of the mobile station and a multimedia subsystem that processes packets for voice communication, the communication control device comprising:
a roaming determining unit that determines whether roaming of voice communication via the multimedia subsystem is supported in the visited network or not; and
an indicator transmitting unit that transmits to any one of the mobility management entity and the mobile station, based on the result of the roaming determination executed by the roaming determining unit, a signal that includes a first support indicator that indicates whether the roaming is supported or not.

6. A mobility management entity that is arranged on a visited network of a mobile station and used in a mobile communication system that includes a communication control device arranged on a home network of the mobile station and a multimedia subsystem that processes packets for voice communication, the mobility management entity comprising:
an indicator receiving unit that receives from the communication control device a first support indicator that indicates whether roaming of voice communication via the multimedia subsystem is supported in the visited network or not; and
a response transmitting unit that transmits to the mobile station a response for a request to connect to the visited network received from the mobile station, wherein the response transmitting unit transmits to the mobile station, based on the first support indicator received by the indicator receiving unit, the response that includes a second support indicator that indicates whether the roaming is supported or not.

7. A mobile communication method that is implemented in a mobile communication system that includes a communication control device arranged on a home network of a mobile station, a mobility management entity arranged on a visited network of the mobile station, and a multimedia subsystem that processes packets for voice communication, the mobile communication method comprising:
transmitting, in which the communication control device transmits to the mobility management entity a signal that includes a first support indicator that indicates whether roaming of voice communication via the multimedia subsystem is supported in the visited network or not;
receiving, in which the mobility management entity receives the first support indicator from the communication control device; and
transmitting, in which the mobility management entity transmits to the mobile station a response for a request to connect to the visited network from the mobile station, wherein
when transmitting the response to the mobile station in the transmitting, the mobility management entity transmits to the mobile station, based on the received first support indicator, the response that includes a second support indicator that indicates whether the roaming is supported or not.

8. The mobile communication system as claimed in claim 2, wherein the roaming determining unit determines whether the roaming is supported or not based on the mobile station type.

9. The mobile communication system as claimed in claim 2, wherein the roaming determining unit determines whether the roaming is supported or not based on a user type of the mobile station.

10. The mobile communication system as claimed in claim 3, wherein the roaming determining unit determines whether the roaming is supported or not based on a user type of the mobile station.

11. The mobile communication system as claimed in claim 8, wherein the roaming determining unit determines whether the roaming is supported or not based on a user type of the mobile station.
